(19) United States
(12) Patent Application Publication
(10) Pub. No.: US 2010/0321198 A1
(43) Pub. Date: Dec. 23, 2010

(54) TICKET WITH INTEGRATED VIDEO

(75) Inventors: Rod S. Berman, Beverly Hills, CA (US); Brennan C. Swain, Santa Monica, CA (US)

Correspondence Address: JEFFER, MANGELS, BUTLER & MITCHELL, LLP, 1900 AVENUE OF THE STARS, 7TH FLOOR, LOS ANGELES, CA, 90067, US

(73) Assignee: Rod and Fabienne Living Trust dated 7/21/95, Los Angeles, CA (US)

(21) Appl. No.: 12/489,363

(22) Filed: Jun. 22, 2009

(51) Int. Cl. G08B 5/00; H04N 5/66

(52) U.S. Cl. 340/815.4; 348/739

(57) ABSTRACT

An event ticket that includes a main body portion, a video screen associated with the main body portion, memory associated with the main body portion and printing on the main body portion indicating the event information. The content to be played on the video screen is stored in the memory.

### FIELD OF THE INVENTION

The present invention relates generally to tickets, and, more particularly, to tickets with integrated video.

### BACKGROUND OF THE INVENTION

To gain access into or participate in many events, such as movies, concerts, sporting events, etc., a ticket is needed. Typically, tickets are printed on paper and cardboard and may have a picture or the like thereon. However, the tickets do not usually have any use other than allowing entry to the event.

Accordingly, a need exists for a use for tickets beyond entry to an event.

### SUMMARY OF THE PREFERRED EMBODIMENTS

In a preferred embodiment of the present invention, there is provided a ticket that includes a main body portion, a video screen associated with the main body portion, memory associated with the main body portion, wherein content to be played on the video screen is stored in the memory, and printing on the main body portion indicating the event information.

In accordance with another embodiment of the present invention, there is provided a method that includes the steps of providing a ticket for an event, wherein the ticket includes a video screen thereon, using the ticket to attend the event, and watching content on the video screen while attending the event.

In accordance with yet another embodiment of the present invention, there is provided a method of providing media content to a person at an event. The method includes the steps of providing the person with a ticket having a video screen, and transmitting media content to the ticket while the person is at the event.

### BRIEF DESCRIPTION OF THE DRAWINGS

The present invention may be more readily understood by referring to the accompanying drawings, in which like numerals refer to like parts, and in which:

FIG. 1 is an elevational view of a video ticket in accordance with an embodiment of the present invention;

FIG. 2 is an elevated view of the video ticket of FIG. 1 in an unfolded position; and

FIG. 3 shows a transmitter transmitting media content to a plurality of video tickets.

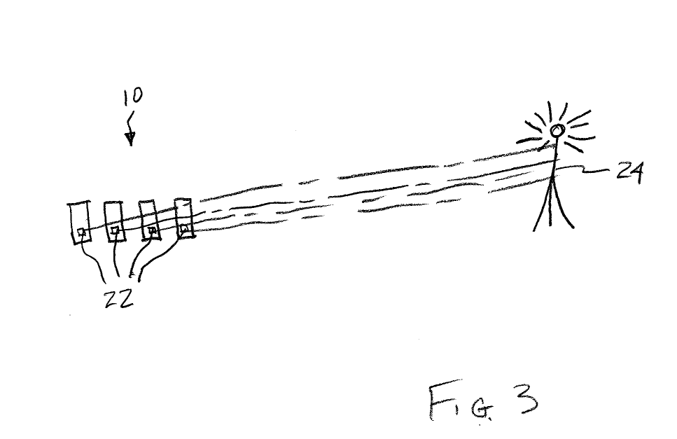

### DETAILED DESCRIPTION OF THE PREFERRED EMBODIMENTS

In the following descriptions of the invention, terms such as “front,” “back,” “top,” “bottom,” “side,” and the like are used herein merely for ease of description and refer to the orientation of the components as shown in the Figures.

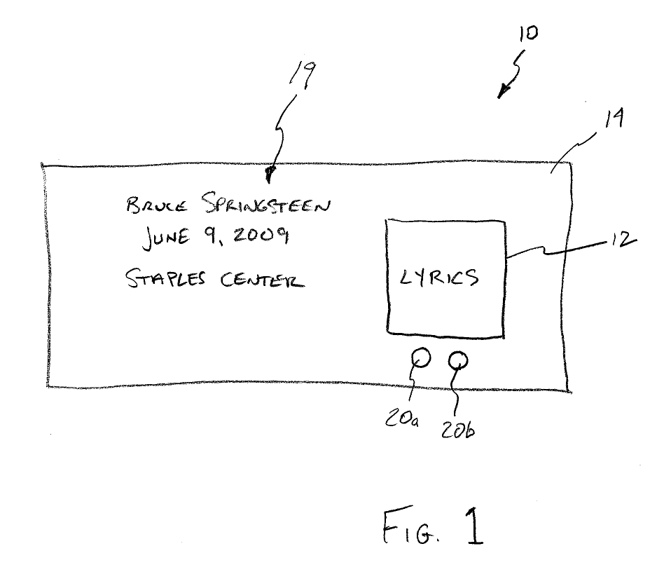

Generally, the present invention may be briefly described as follows. Referring to FIG. 1, a ticket 10 that includes a video screen 12 is shown. Video displays are known in the art including video displays that are incorporated into cards, magazines and the like. For example, see U.S. Pat. No. 7,436,318 to Affolter (the “'318 Patent”), the entirety of which is incorporated herein be reference. The '318 Patent teaches many of the necessary components for allowing video to be used in a thin package, such as a magazine or the like. The same technology applies for integrating the video screen into a ticket, such as a printed cardboard ticket. For example, many of the internal components taught in the '318 application, e.g., switches, microchips, speaker, mic, video screen, buttons, etc. can be used with ticket 10. Generally, any type of video screen that is thin and can be incorporated into the ticket 10 is within the scope of the present invention. For example, the video screen 12 can include LCD (liquid crystal display) technology or any other type of video screen technology known in the art, such as monochrome, electro-chromic, TFT (thin film transistor), OLED (organic light emitting diode), CSTN (color super-twist nematic), DSTN (double layer STN, dual scan STN), FRSTN (fast response STN), FSTN (film compensated STN, formulated STN or filtered STN), FFSTN (double film super-twist nematic), MSTN (monochrome super-twist nematic), active-matrix electrophoretic display (e-ink) or any other video screen technology now known or later developed.

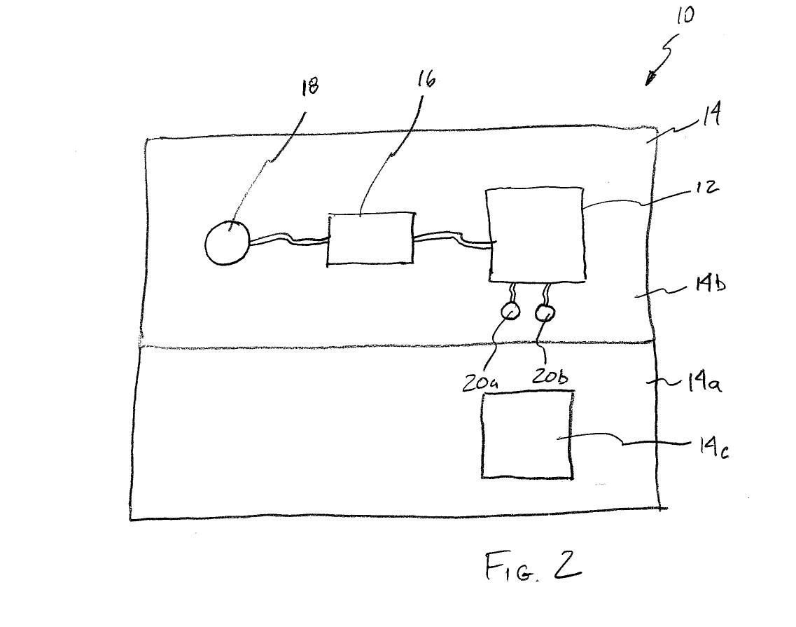

Referring to FIGS. 1-2, in an exemplary embodiment of the present invention, the ticket 10 includes a main body portion 14, a microchip 16 that includes memory on which information or content is stored and a power source 18. In a preferred embodiment, power source 18 is comprised of button batteries of sufficient size to power the microchip and any related software. However, any miniature mountable power source of sufficient power may be used such as, but not limited to, solar cells, direct drives, mechanically driven drives and the like. The preferred button batteries used to power the device are of sufficient capacity as to allow the device to be operated repeatedly for several months.

The main body portion 14 can be made of a piece of foldable cardboard or the like. For example, as shown in FIG. 2, the main body portion 14 can include a front 14a and a back 14b that are foldable. The front 14a can include a window 14c for allowing viewing of the video screen 12. The ticket 10 can also include a speaker for playing audio that is either related to or unrelated to the video content.

In a preferred embodiment, the ticket 10 includes event information 19 printed or otherwise placed thereon. The event information may include, but is not limited to time, date, venue, name of the event, artist, team, production, city, state, etc.

The video screen 12 on the ticket 10 can be useful in a number of different situations. For example, when people attend concerts they often like to sing along to the songs. The memory can contain the lyrics to the band's songs, and the user can scroll through or play the lyrics using push buttons or switches 20a and 20b. Any number of buttons are within the scope of the present invention.

The memory can be preprogrammed and unchangeable, or can be changeable by the user or the venue putting on the event. In a preferred embodiment, the content displayed on the video screen is related to the event and the event information. For example, at a concert, the content may be lyrics or videos of the bands songs, information about the band members or an upcoming album. At a sporting event, the content may be statistics, replays of past events or highlights, short videos about the players, etc. At a movie, the content may be trailers for coming attractions, movie related press, etc. A ski lift pass may contain a trail map or videos of people skiing or snowboarding. The content can also be unrelated to the event. For example, the content can be advertisements, commercials, TV shows, films, etc.

In another embodiment, the ticket 10 can include a receiver 22 that receives from signals from a transmitter 24 that transmits content to the ticket during the event. For example, during a concert, lyrical content can be transmitted to the receiver and displayed on the screen 12. This way everyone in the audience receives the information related to the song being played by the band simultaneously. During a sporting event replays can be transmitted to the ticket 10 and played on the screen 12.

In another embodiment, the ticket can include a voting feature where audience members can use buttons or the like to enter votes. For example, at a concert, concertgoers could vote for what song to play next or at a TV game show taping, audience members can vote for their favorite contestant, etc.

The ticket may also include ports for uploading or downloading data, and may also include a port for charging the battery.

The embodiments and methods described above are exemplary embodiments and methods of the present invention. While particular embodiments of the present invention have been illustrated and described, it will be apparent that various modifications can be made without departing from the spirit and scope of the invention. Those skilled in the art may now make numerous uses of, and departures from, the above-described embodiments and methods without departing from the inventive concepts disclosed herein. Thus, the construction of the embodiments and the steps of the methods disclosed herein are not limitations of the invention. Accordingly, the present invention is to be defined solely by the scope of the following claims.

What is claimed is:

1. A ticket comprising:
a main body portion,
a video screen associated with the main body portion,
memory associated with the main body portion, wherein content to be played on the video screen is stored in the memory, and
printing on the main body portion indicating the event information.

2. The ticket of claim 1 wherein the content is related to the event information.

3. A method comprising the steps of:
providing a ticket for an event, wherein the ticket includes a video screen thereon,
using the ticket to attend the event, and
watching content on the video screen while attending the event.

4. The method of claim 3 wherein the ticket includes event information printed thereon, and wherein the content is related to the event information.

5. A method of providing media content to a person at an event, the method comprising the steps of:
providing the person with a ticket having a video screen, and
transmitting media content to the ticket while the person is at the event.

6. The method of claim 5 wherein the media content is transmitted to a plurality of tickets at the event.

7. The method of claim 5 wherein the ticket includes a receiver.
